(19) United States
(12) Patent Application Publication
(10) Pub. No.: US 2004/0037565 A1
(43) Pub. Date: Feb. 26, 2004

(54) Transport of signals over an optical fiber using analog RF multiplexing

(76) Inventors: Robin Young, San Jose, CA (US); Simon P Yeung, Cupertino, CA (US); Lance Uyehara, San Jose, CA (US); Adam Schwartz, Campbell, CA (US); Baljit Singh, San Jose, CA (US); Peter Sydor, Los Angeles, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/227,614

(22) Filed: Aug. 22, 2002

(51) Int. Cl. H04B 1/04; H04B 10/00

(52) U.S. Cl. 398/115; 398/116

(57) ABSTRACT

In a wireless communication network, a method for transporting signals between a base station hotel and a remote cell site allows multiple uplink and downlink signals to be communicated using a single optical fiber. In a preferred embodiment of the invention, an RF transport technique uses frequency translation to shift the common carrier frequencies of diversity and sector signals to distinct intermediate frequencies that are then combined, converted to an optical signal and transmitted over a single fiber. The RF transport technique also uses wavelength division multiplexing (WDM) to communicate both uplink and downlink signals over the same fiber. Reference clock signals are distributed to ensure accurate frequency translation at both ends of the link. Reference power signals are also transmitted in both uplink and downlink to help perform signal power equalization.

### FIELD OF THE INVENTION

The present invention relates generally to wireless communication systems. More specifically, it relates to techniques for transporting signals from a base station hotel to remote transmitters using optical fibers.

### BACKGROUND OF THE INVENTION

Wireless communication systems, and cellular system in particular, are evolving to better suit the needs of increased capacity and performance demands. Currently cellular infrastructures around the world are upgrading their infrastructure to support the third generation (3G) wireless frequency spectrum. Unfortunately, the tremendous capital resources required to upgrade the entire cellular system infrastructure inhibits the deployment of these 3G systems. It is estimated that up to 3 million 3G cell sites will be needed around the world by 2010.

Traditionally, a cellular base station is positioned at or near the center of the area in which cellular coverage is to be provided, as shown in FIG. 1. In addition to a base station 100, a cell site 104 also includes an antenna tower, antennas, an equipment room, and a number of other relevant components 102. Similarly, cell sites 106 and 112 have base stations 106 and 112, as well as associated components 108 and 114, respectively. This traditional approach of deploying all the cell site equipment locally has several drawbacks that contribute to the expense of the infrastructure, and upgrades to the infrastructure. At each cell site, a BTS room or cabinet to host the large base station equipment is required, as well as additional electric power supplies for the base station. This increases both the costs of the equipment at each site, as well as the costs of acquiring and renting the physical location for the equipment. The cell site equipment must be designed for future coverage and capacity growth, and upgrades to the equipment require physical access to the cell site.

To mitigate these problems, some cellular systems have been designed with a different architecture, as shown in FIG. 2. The base station equipment for multiple cell sites is centralized in a base station hotel 200, while the antenna towers and antennas for the various cell sites 202, 204, 206 are located at a distance from the base station hotel. Separating the base station equipment from the antennas, however, makes it necessary to transport RF signals between the base station hotel 200 and the various cell sites 202, 204, 206 that it serves. Current systems conventionally use several broadband fiber optic cables 208, 210 212, together with appropriate electro-optical converter (EOC) equipment for translating between RF and optical signals for transport over the fiber optic link. The optical link between the base station hotel and each remote site must be able to carry both uplink and downlink signals. Typically, two uplink and two downlink signals are used to provide signal diversity. In addition, the typical cell site handles three separate sectors, each serving 120 degrees of coverage. Given that a cell site supports three sectors and each sector supports two downlink and uplink diversity signals, a total of twelve separate fibers are required to connect each remote cell site to the centrally located base station hotel. This requirement for twelve fibers in each of the cables 208, 210, 212 significantly impacts the expense of this alternate architecture.

### SUMMARY OF THE INVENTION

The present invention provides a system and method for transporting signals between a base station hotel and a remote cell site that requires only a single optical fiber. This invention thus significantly reduces the required leasing cost of optical fiber backhaul and makes the centralized base station hotel architecture economically feasible for the 3G network rollout. Embodiments of the invention are based upon a new RF transport technique that allows multiple uplink and downlink signals to be communicated using a single optical fiber. For example, uplink and downlink signals for multiple sectors, uplink and downlink diversity signals, as well as other signals may be multiplexed and transmitted over a single optical fiber between a base station hotel and a remote site. In one aspect of the invention, the RF transport technique uses frequency translation to shift the common carrier frequencies of diversity and sector signals to distinct intermediate frequencies so that the signals can be transmitted over a single fiber. The RF transport technique also uses wavelength division multiplexing (WDM) to communicate both uplink and downlink signals over the same fiber.

More specifically, an embodiment of the invention provides a method of wireless communication comprising:

a) generating at a base station a plurality of downlink RF signals having a common carrier frequency, frequency translating the downlink RF signals to produce corresponding IF downlink signals having distinct intermediate frequencies, combining the IF downlink signals to produce a combined downlink signal, and converting the combined downlink signal to a downlink optical signal centered at a downlink optical wavelength;

b) communicating the downlink optical signal over a single optical fiber to a remote site;

c) converting the downlink optical signal to recover the combined downlink signal, separating the combined downlink signal to recover the IF downlink signals, frequency translating the IF downlink signals to recover the downlink RF signals, and transmitting the downlink RF signals from antennas at the remote site;

d) receiving from the antennas at the remote site a plurality of uplink RF signals having a common carrier frequency, frequency translating the uplink RF signals to produce corresponding IF uplink signals having distinct intermediate frequencies, combining the IF uplink signals to produce a combined uplink signal, and converting the combined uplink signal to a uplink optical signal centered at an uplink optical wavelength;

e) communicating the uplink optical signal over the single optical fiber from the remote site;

f) converting the uplink optical signal to recover the combined uplink signal, separating the combined uplink signal to recover the IF uplink signals, and frequency translating the IF uplink signals to recover the uplink RF signals.

The remote site may comprise a remote hub and multiple remote nodes, and the method may further comprise communicating IF signals between the hub and remote nodes.

In another aspect of the invention, the method may also include distributing a reference clock signal from the base station hotel to the remote site, and using the reference clock signal in the frequency translation at the remote site to improve accuracy of frequency translation. In an additional aspect of the invention, the method may include generating at the base station a downlink pilot signal, measuring at the remote site the strength of the downlink pilot signal, and using the measured strength to adjust power levels of the downlink RF signals. An analogous technique is used for equalization of uplink signal power levels.

### BRIEF DESCRIPTION OF THE DRAWINGS

FIG. 1 is a schematic diagram of a traditional architecture for a wireless communication system wherein each remote cell site includes its own local base station equipment.

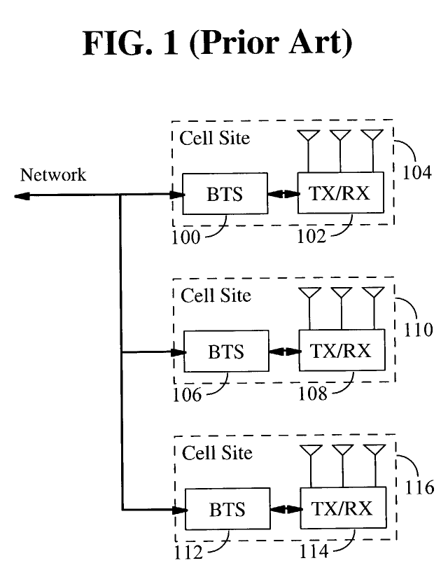

FIG. 2 is a schematic diagram of an alternate architecture for a wireless communication system wherein the base station equipment for various remote sites is centralized in a base station hotel, which communicates with each remote site using multiple optical fibers.

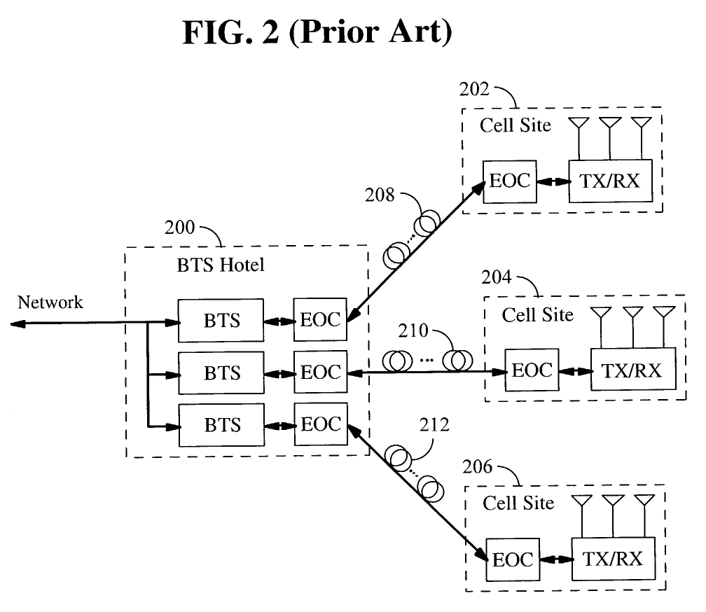

FIG. 3 is a diagram illustrating an RF multiplexing technique according to a preferred embodiment of the present invention.

FIG. 4 is a diagram illustrating a first network architecture implementing the RF transport techniques of the present invention.

FIG. 5 is a diagram illustrating a second network architecture implementing the RF transport techniques of the present invention.

FIG. 6 is a diagram illustrating a third network architecture implementing the RF transport techniques of the present invention.

FIG. 7 is a block diagram of a local hub used in an implementation of a preferred embodiment of the present invention.

FIG. 8 is a block diagram of a remote site used in an implementation of a preferred embodiment of the present invention.

### DETAILED DESCRIPTION

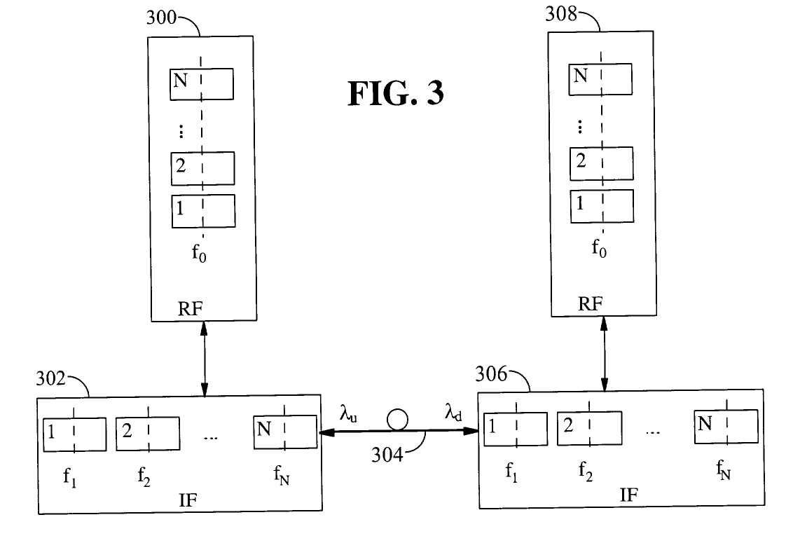

A preferred embodiment of the invention will now be described with reference to the drawing figures. According to this embodiment, RF signals are transported between a base station hotel and remote sites using the RF multiplexing technique illustrated in FIG. 3. At the base station hotel a number N of downlink RF signals 300 having a common carrier frequency f₀ are frequency translated to corresponding downlink IF signals 302 having distinct intermediate frequencies f₁, . . . , f_{N}. Intermediate frequencies f₁, . . . , f_{N} are selected to coincide with commercially available components, such as filters, mixers and amplifiers. In the case where these RF signals are intended for transmission from a cell site with three sectors, one RF channel per sector, and two diversity channels per sector, N=6. If one or more out-of-band signaling or control channels are needed, N can be increased to accommodate them as well, and each of these signals is handled in the same as any one of the RF signals. The resulting frequency shifted signals 302 are then combined and the resulting IF signal is converted to an optical signal centered at wavelength λ_{d}. This optical signal is transmitted over a single optical fiber 304 from the base station to the remote site where it is converted back to an IF signal and split into its N components centered at distinct IF frequencies. These IF components 306 are then frequency shifted back to a common carrier frequency f₀, thereby recovering the original downlink RF signals 308 generated by the base station. These N downlink signals are then transmitted from the antennas at the remote site to cellular subscribers in the cell's service area.

A set of N uplink signals are also received from the subscribers, and these N signals are transported back to the base station over the same optical fiber. The frequency shifting and combining technique used for the downlink signals is the same as that used to transport the uplink signals, with the exception that the uplink signals are converted to an optical signal centered at a wavelength λᵤ distinct from λ_{d}. In other words, wavelength division multiplexing is used to allow both uplink and downlink signals to share a single optical fiber. More generally, RF frequency translation and the use of distinct optical wavelengths (using, for example, CWDM or DWDM) may be used to increase the bandwidth of a single fiber as required to transport various uplink and downlink RF signals. As will be illustrated further below, the techniques may also be used for transporting distinct RF signals from several base stations to the same remote site over a single fiber. For example, three base stations can use six distinct wavelengths λᵤ₁, λᵤ₂, λᵤ₃, λ_{d1}, λ_{d2}, λ_{d3} to handle their uplink and downlink RF signals. Alternatively, the signals from the three base stations can be frequency multiplexed using frequency translation so that they can all be transported using the two wavelengths λᵤ and λ_{d}.

In the preferred embodiment, techniques are employed to minimize signal distortions introduced during RF multiplexing and optical transport. One potential source of distortion is a small difference between the clock frequencies used to perform frequency translation at different ends of the fiber. To address this problem, a reference clock is used to provide a frequency standard that enables accurate RF frequency translation at both ends. Preferably, the clock is located at the base station hotel and generates a reference clock signal that is then distributed to each remote cell site. If the reference clock is not located at the base station hotel, the reference clock signal would need to be communicated to the base station hotel as well. The clock signal could be multiplexed in the same manner as the RF signals, thus increasing N by one. Alternatively, the clock signal could be transmitted over a separate communication channel (e.g., by including GPS receivers at the base station hotel and the various remote sites, the GPS satellite network could provide a common clock signal for the system). In a preferred embodiment, conversion between RF and IF at the two ends of the optical transport is performed by mixing with local oscillator signals that are derived from a reference clock signal. The clock signal is preferably a single CW tone with standard frequency stability. The clock signal is frequency multiplexed along with the analog IF signals on the single optical fiber.

Another potential type of signal distortion that could be introduced during transport is power level variation. One of the key requirements for transporting analog signals is the maintenance of power levels and gain throughout the transport link. Power levels, and hence gain, may vary with temperature, cable length and other component variations. If the signal power is too low, then the link may be causing excessive signal-to-noise ratio (SNR) degradation. If the signal power is too high, then the link may be causing signal distortion and excessive intermodulation products. To address this problem, the preferred embodiment of the invention provides a means for selecting either amplification (positive gain) or attenuation (negative gain) and maintaining the selected gain setting to within a specified tolerance. This gain control is achieved using pilot signals, which are frequency multiplexed along with the RF signals and any additional data and control channels. Preferably, the pilot signal is generated at the base station hotel and transmitted at a known power level to the remote sites. Upon reception at the remote site, the pilot signal is measured and compared to stored reference levels. If a difference is detected, the appropriate correction to the RF signals is performed. This adaptive level control (ALC) technique thus serves to preserve signal and gain levels from one end of the system to the other. The ALC technique equalizes gain to a specified range over the optical fiber link, and may also provide power equalization over coaxial links in the network as well. The gain equalization preferably operates over specified input power, temperature and cable length ranges.

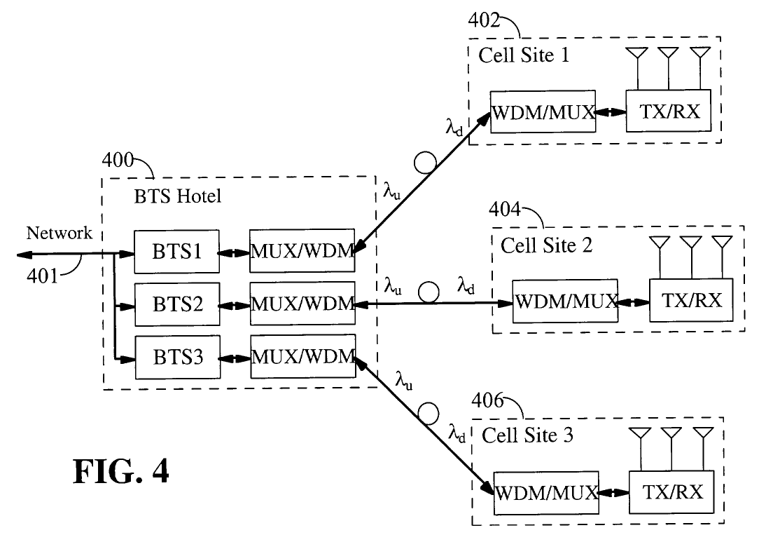

The RF transport technique described above may be used advantageously in various different ways and in various different network architectures. FIG. 4, for example, illustrates a network architecture used in one embodiment of the invention. A base station hotel 400 connected to a high bandwidth switched network 401 contains a set of base stations. For simplicity of illustration, three base stations (BTS1, BTS2, BTS3) are shown with corresponding cell sites 402, 404, 406. Each base station in the hotel typically generates RF signals to be transmitted from a single corresponding remote cell site. These downlink signals include signals for several sectors, diversity signals, as well as control signals. Using RF multiplexing techniques implemented using multiplexers and optical interface equipment (MUX/WDM) at the BTS hotel 400 and cell sites 402, 404, 406, only a single optical fiber is needed to transport all these signals from the base station hotel to a remote cell site. In addition, using WDM the single fiber also carries the uplink signals from the remote cell site to the base station hotel.

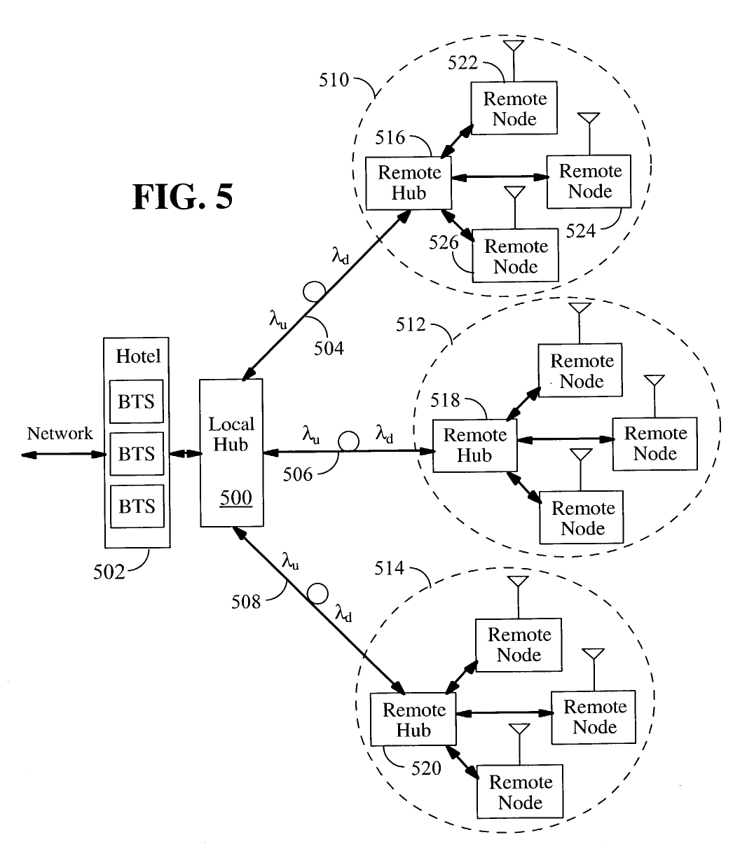

A more modular architecture that may be used advantageously with the techniques of the invention is shown in FIG. 5. In this embodiment, a Local Hub (LHub) 500 receives via coaxial cable RF signals generated by a base station hotel 502 and converts these RF signals to optical signals to be transported over the single fiber optical links 504, 506, 508 to remote sites 510, 512, 514 having remote hubs (RHubs) 516, 518, 520, respectively. At each remote site, its Remote Hub (RHub) converts the optical signals back to IF signals, and communicates the IF signals for each sector via coaxial cable to the appropriate Remote Node (RNode) where they are frequency shifted and transmitted. For example, at remote site 510, RHub 516 sends IF signals to three RNodes 522, 524, 526. The coaxial cable connections are preferably on the order of meters or tens of meters at most, while the optical fibers are typically on the order of hundreds or thousands of meters. Separate RNodes are employed for each sector antenna so that the transmit power amplifier and receive low noise amplifier modules may be located in close proximity to the antenna. This configuration reduces signal attenuation due to cabling, thereby enabling maximum transmit power and receive sensitivity. As shown in FIG. 5, these components may be configured in a double-star architecture, with a single LHub connecting to multiple RHubs, in turn connecting to multiple RNodes. Preferably, the RHub is AC powered and provides necessary DC power to its RNodes. Three base stations and three RHubs are shown for illustration only. In general, there may be any number of base stations in the hotel, and any number of RHubs connected to the LHub. In addition, at each remote site there may be any number of RNodes connected to each RHub.

The double-star architecture allows the one-to-one correspondence between base stations in the hotel and RHubs to be configured for a one-to-many correspondence. That is, the system may be configured so that several RHubs receive the same signals from a common base station in the hotel. This configuration thus allows signals generated from a single base station to be sent to several remote cell sites that are at different locations. This configuration provides simulcast coverage across each remote site, enabling significant cost savings over the deployment of separate BTS equipment at each site. Optical signal splitting means may be added to the LHub to generate multiple copies of the downlink optical signal for transmission to the RHubs of each cell site. An IF signal combiner also may be added to the LHub to merge the uplink signals received from the RHubs of each cell site.

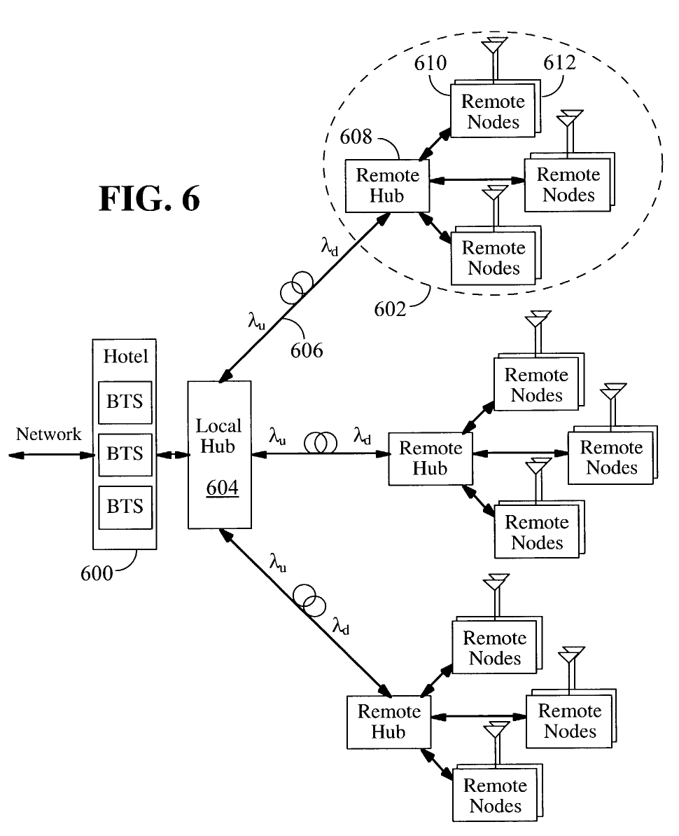

Yet another configuration, illustrated in FIG. 6, allows the transmission of RF signals from several base stations in hotel 600 to the same cell site, e.g., remote site 602. This technique might be useful, for example, if multiple wireless operators want to share a cell site at the same location. In this configuration, the correspondence between base stations and RHubs may be many-to-one. At the LHub 604, the RF signals generated by two or more base stations are frequency translated to distinct sets of intermediate frequencies so that they can both be simultaneously transported over a single optical fiber to a remote site, e.g., over fiber 606 to site 602. For example, if each of two base stations generates 6 RF signals, then a total of 12 RF signals centered at a common carrier frequency can be frequency translated to distinct intermediate frequencies f₁, . . . , f₁₂ and transmitted over the optical fiber 606 at a downlink wavelength λ_{d}. At the remote hub 608, the 12 IF signals are frequency translated back to their original carrier frequencies. According to this configuration, both base stations share the same optical bandwidth between the LHub 604 and RHub 608, but have distinct RNodes and transmitters at each sector of the remote site (e.g., nodes 610 and 612). In addition, or alternatively, WDM techniques can be used to transport the additional signals over the fiber. If a single fiber does not have sufficient bandwidth to multiplex the 12 RF signals from both base stations, two fibers can be used, one for each base station. This configuration may be viewed as an overlay of two one-to-one systems that share the same LHubs and RHubs, but are otherwise distinct. In this arrangement, there is no need to add intermediate channels to the frequency translation plan for each fiber.

As with any piece of telecommunication-related equipment, there is an expectation that the system be configurable, monitorable and maintainable. A preferred embodiment of the invention allows centralized operations, administration and maintenance (OA&M) for the entire configuration through an interface at the LHub. OA&M interfaces may also be provided at the RHubs. The system thus supports a series of external and internal asynchronous bi-directional serial data communication links for OA&M purposes such as message passing for normal operation, system configuration, firmware updates, test, calibration and alarm monitoring. An interface may be provided at the LHub to enable an external host device to connect to the system and perform OA&M functions. This interface may support the Simple Network Management Protocol (SNMP). The digital data for the serial links is preferably modulated onto a carrier using frequency shift keying (FSK) modulation and the resulting carrier is frequency multiplexed with the analog IF payload for transport over the optical fiber between the LHub and RHub. The serial data may be transported from the RHub to the RNode over coaxial cables or over twisted-pair serial data cables in either a point-to-point or multi-drop architecture.

Additionally, the preferred embodiment of the invention supports the transport of various other signals such as data, administration and control signals. These signals are preferably modulated onto a carrier using FSK and the resulting carrier is frequency multiplexed with the analog IF payload over the optical fiber. Examples of these types of communication links include: (1) multiple European E-carrier system E-1 or North American T-carrier system T-1 trunking links between the base station and remote cell site. (2) Full-duplex serial data communication link between the base station and cell site for remote site equipment control. The link enables a host device at the LHub location to connect to and control external equipment at the remote site location, such as an antenna steering subsystem. (3) An Ethernet-based TCP/IP communication link between the BTS and cell site. The link enables a host device at the remote site location to connect to, configure and monitor the BTS. (4) A bi-directional voice communication link between the BTS and cell site. This link enables field personnel at the main hub location to converse with field personnel at the Remote Hub location. The voice signal for said link is preferably modulated onto a carrier using analog frequency modulation (FM).

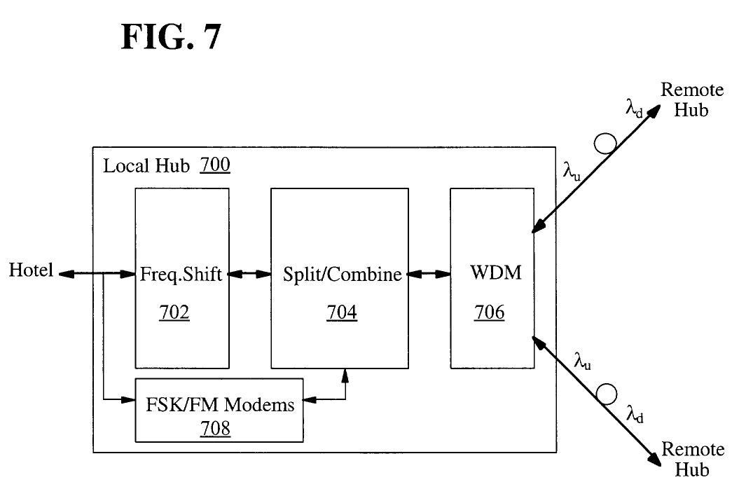

A block diagram of an LHub 700 according to a preferred embodiment of the invention is shown in FIG. 7. A set of RF signals from a base station hotel arrive via coaxial cable and are frequency translated to a set of distinct intermediate frequency signals by a frequency shift block 702. In a typical configuration, the set of RF signals originate from a single base station in the hotel, but in other configurations may originate from more than one base station. The distinct, non-overlapping intermediate frequency signals are then combined by a splitter/combiner block 704 and fed to a WDM transceiver block 706 where the combined signal is converted into an optical downlink signal centered at a downlink wavelength. In a typical configuration, the optical downlink signal is then transmitted over a single optical fiber to a single remote site. In other configurations, the optical signal is transmitted to several remote sites. Similarly, an uplink optical signal from an RHub at a remote site arrives at the WDM transceiver block 706 where it is converted into a combined RF signal which is separated by the splitter/combiner block 704 into a set of intermediate frequency signals. At the frequency translator block 702 these intermediate signals are frequency shifted back to their original carrier frequencies and the resulting RF signals are fed to the base station hotel via coaxial cable. In a typical configuration, these RF signals are intended for a single base station in the hotel, but in other configurations the RF signals are intended for several base stations in the hotel.

It should be noted that the set of RF signals typically includes sector and diversity signals generated by single base station, but may also include similar RF signals generated by one or more separate base stations. The RF signals from separate base stations are either frequency multiplexed together and sent over the same fiber at the same wavelength, or they are frequency multiplexed separately in parallel and not combined with each other. In this latter case, the separate combined signals are either sent over the same fiber at distinct wavelengths, or sent over distinct fibers. If they are sent over distinct fibers, they may be sent to the same RHub, or to different RHubs. Analogous remarks apply to the uplink signals.

The LHub 700 also includes a multi-channel FSK/FM modem block 708, which preferably provides Ethernet, serial, E1/T1 and voice link interfaces with the base station hotel. Signals such as remote site base station control, remote site equipment control, 2G BSC-BTS support, and voice data are appropriately modulated by the modem block, combined with the IF payload signals, and sent to the WDM transceiver block for transmission to the remote site. Similarly, signals from the remote site are converted back to their native format by the FSK/FM modem block 708 and provided to the base station hotel.

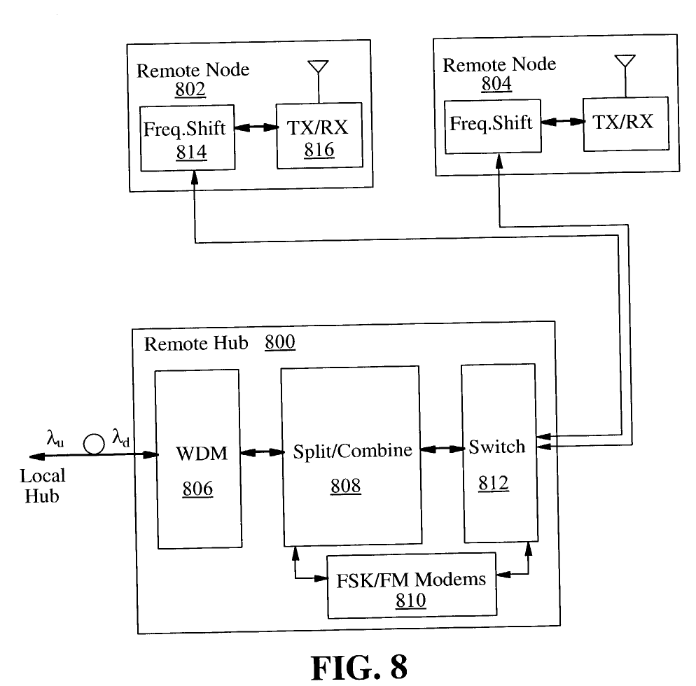

A block diagram of a remote site according to a preferred embodiment of the invention is shown in FIG. 8. The site comprises an RHub 800 and one or more RNodes 802, 804 connected via coaxial cable to the RHub 800. A WDM transceiver block 806 in the RHub converts an optical signal into an IF signal that is then fed to a splitter/combiner block 808. The IF signal is split into separate signals by the splitter/combiner block 808, and the resulting separated IF signals are routed by a switch 812 and sent via coaxial cable to the appropriate remote nodes 802, 804. A frequency translation block 814 at the remote node 802, for example, converts the IF signals to RF signals which are then appropriately amplified and transmitted from the antennas at block 816. Uplink signals follow an analogous reverse path. At the RNode 802 RF signals are received at the antennas and sent through a low noise amplifier in block 816. The signals are then frequency shifted to IF at block 814. The IF signals are then transmitted via coaxial cable to the RHub 800 where the IF signals are combined at 808 and converted at 806 to optical signals for transmission over the optical fiber to the LHub. The remote site also contains appropriate FSK/FM modems 810 and related components to support auxiliary channels and other signals that may be desired or required.

Each RNode 802, 804 may be connected to the RHub 800 by either an uplink coaxial cable for uplink IF signals and a downlink coaxial cable for downlink IF signals, or a single coaxial cable for both uplink and downlink signals. In the latter case, the downlink and uplink IF frequencies are selected so as not to overlap, thereby enabling frequency duplexing over a single cable. In any case, the coaxial cable linking the RHub 800 to its nodes 802, 804 is on the order of meters or tens of meters. In a typical implementation, each RNode 802, 804 at a cell site corresponds to a unique sector of the cell site, and the RHub 800 serves a single cell, such as a building or small geographical region. Note that FIG. 8 shows two RNodes for illustration purposes only, and that any number of RNodes may be connected to an RHub.

In general, several non-overlapping carrier signals may be transmitted from each sector, such as when the antennas of one sector use several distinct frequency bands for communication with various sets of subscribers. Preferably, the number of carriers supported is between 1 and 20. These carriers can be transported over the single optical link using the same multiplexing techniques of the present invention. For example, a set of M carriers, each with N signals can be frequency shifted using the same technique as for the N signals shown in FIG. 3. The resulting set of N×M IF signals are then combined and converted to an optical signal that is transmitted over a single fiber. At the remote hub, the IF signals are separated and frequency shifted, then routed to the appropriate nodes where they are converted to RF signals and transmitted from the appropriate sectors. The uplink signals are transported in the analogous reverse process.

The inventors claim:

1. In a wireless communication network, a method comprising:
a) generating at a base station a plurality of downlink RF signals having a common carrier frequency, frequency translating the downlink RF signals to produce corresponding IF downlink signals having distinct intermediate frequencies, combining the IF downlink signals to produce a combined downlink signal, and converting the combined downlink signal to a downlink optical signal centered at a downlink optical wavelength;
b) communicating the downlink optical signal over a single optical fiber to a remote site;
c) converting the downlink optical signal to recover the combined downlink signal, separating the combined downlink signal to recover the IF downlink signals, frequency translating the IF downlink signals to recover the downlink RF signals, and transmitting the downlink RF signals from antennas at the remote site;
d) receiving from the antennas at the remote site a plurality of uplink RF signals having a common carrier frequency, frequency translating the uplink RF signals to produce corresponding IF uplink signals having distinct intermediate frequencies, combining the IF uplink signals to produce a combined uplink signal, and converting the combined uplink signal to a uplink optical signal centered at an uplink optical wavelength;
e) communicating the uplink optical signal over the single optical fiber from the remote site;
f) converting the uplink optical signal to recover the combined uplink signal, separating the combined uplink signal to recover the IF uplink signals, and frequency translating the IF uplink signals to recover the uplink RF signals.

2. The method of claim 1 further comprising generating a reference clock signal, communicating the reference clock signal to the remote site, and using the reference clock signal in the steps of frequency translating the downlink RF signals, frequency translating the uplink IF signals, frequency translating the uplink RF signals and frequency translating the downlink IF signals.

3. The method of claim 1 further comprising:
a) generating at the base station a downlink pilot signal, communicating the downlink pilot signal to the remote site, measuring at the remote site the strength of the communicated downlink pilot signal, and using the measured strength at the remote site to appropriately adjust power levels of the downlink RF signals;
b) generating at the remote site an uplink pilot signal, communicating the uplink pilot signal to the base station, measuring at the base station the strength of the communicated uplink pilot signal, and using the measured strength at the base station to appropriately adjust power levels of the uplink RF signals.

4. The method of claim 1 further comprising communicating the downlink optical signal over a second optical fiber to a second remote site.

5. The method of claim 1 further comprising generating at a second base station a plurality of second downlink RF signals having a common carrier frequency, and combining the second downlink RF signals with the downlink RF signals, whereby the second downlink RF signals are also communicated over the single optical fiber to the remote site.

6. The method of claim 1 further comprising generating at a second base station a plurality of second downlink RF signals having a common carrier frequency, frequency translating the second downlink RF signals to produce corresponding second IF downlink signals having distinct intermediate frequencies, combining the second IF downlink signals to produce a second combined downlink signal, converting the second combined downlink signal to a second downlink optical signal centered at a second downlink optical wavelength, and communicating the second downlink optical signal over the single optical fiber to the remote site.

7. The method of claim 1 wherein the remote site comprises a remote hub and a plurality of remote nodes connected to the remote hub, wherein the steps of converting the downlink optical signal to recover the combined downlink signal, and separating the combined downlink signal to recover the IF downlink signals are performed at the remote hub, wherein the steps of frequency translating the IF downlink signals to recover the downlink RF signals, and transmitting the downlink RF signals from antennas at the remote site are performed at the remote nodes, and wherein the method further comprises communicating the IF downlink signals from the remote hub to the remote nodes.

8. The method of claim 1 wherein the wireless communication network comprises a base station hotel and a local hub, wherein the step of generating at a base station a plurality of downlink RF signals having a common carrier frequency is performed at the base station hotel, and wherein the steps of frequency translating the downlink RF signals to produce corresponding IF downlink signals having distinct intermediate frequencies, combining the IF downlink signals to produce a combined downlink signal, and converting the combined downlink signal to a downlink optical signal centered at a downlink optical wavelength are performed at the local hub.

9. The method of claim 1 wherein the downlink RF signals comprise downlink sector signals and downlink diversity signals, and wherein the uplink RF signals comprise uplink sector signals and uplink diversity signals.

10. A wireless communication system comprising:
a) a base station for generating a plurality of downlink RF signals having a common carrier frequency;
b) a local hub comprising a frequency shifter for frequency translating the downlink RF signals to produce corresponding IF downlink signals having distinct intermediate frequencies, a splitter/combiner for combining the IF downlink signals to produce a combined downlink signal, and a WDM transceiver for converting the combined downlink signal to a downlink optical signal centered at a downlink optical wavelength;
c) an optical fiber for communicating the downlink optical signal to a remote site;
d) a remote hub comprising a WDM transceiver for converting the downlink optical signal to recover the combined downlink signal, and a splitter/combiner for separating the combined downlink signal to recover the IF downlink signals; and
e) a remote node comprising a frequency shifter for frequency translating the IF downlink signals to recover the downlink RF signals, and a transmitter for transmitting the downlink RF signals from antennas at the remote site.

11. The system of claim 10 wherein the remote node receives from the antennas at the remote site a plurality of uplink RF signals having a common carrier frequency, and frequency translates the uplink RF signals to produce corresponding IF uplink signals having distinct intermediate frequencies; wherein the remote hub combines the IF uplink signals to produce a combined uplink signal, and converts the combined uplink signal to a uplink optical signal centered at an uplink optical wavelength; wherein the optical fiber communicates the uplink optical signal from the remote site to the local hub; and wherein the local hub converts the uplink optical signal to recover the combined uplink signal, separates the combined uplink signal to recover the IF uplink signals, and frequency translates the IF uplink signals to recover the uplink RF signals.

12. In a wireless communication network device, a method comprising:
a) receiving from a base station a plurality of downlink RF signals having a common carrier frequency;
b) frequency translating the downlink RF signals to produce corresponding IF downlink signals having distinct intermediate frequencies;
c) combining the IF downlink signals to produce a combined downlink signal,
d) converting the combined downlink signal to a downlink optical signal centered at a downlink optical wavelength;
e) transmitting the downlink optical signal over a single optical fiber to a remote site.

13. The method of claim 12 further comprising:
a) receiving an uplink optical signal over the single optical fiber from the remote site;
b) converting the uplink optical signal to recover a combined uplink signal;
c) separating the combined uplink signal to recover IF uplink signals; and
d) frequency translating the IF uplink signals to recover uplink RF signals.

14. The method of claim 13 further comprising transmitting a reference clock signal to the remote site, and using the reference clock signal in frequency translating the uplink IF signals.

15. The method of claim 12 further comprising receiving a reference clock signal to the remote site, and using the reference clock signal in frequency translating the downlink RF signals.
